(19) United States
(12) Patent Application Publication
(10) Pub. No.: US 2007/0112828 A1
(43) Pub. Date: May 17, 2007

(54) Methods, systems, and computer-readable media for creating a collection of experience-related data from disparate information sources

(76) Inventor: Steven Tischer, Atlanta, GA (US)

Correspondence Address: MERCHANT & GOULD BELLSOUTH CORPORATION, P.O. BOX 2903, MINNEAPOLIS, MN, 55402, US

(21) Appl. No.: 11/272,889

(22) Filed: Nov. 14, 2005

(51) Int. Cl. G06F 7/00

(52) U.S. Cl. 707/102

(57) ABSTRACT

Methods, systems, and computer-readable media are provided for creating a collection of experience-related data from disparate information sources. In a communications device, a marker is received indicating an experienced event, the marker is annotated with the current state of environmental variables, data collected from disparate information sources which is related to the experienced event is saved, a description is provided for the saved event data. The saved event data may optionally be automatically sent to an aggregation source in a communications network for retrieval. If a change in the environmental variables is detected, the beginning of a new event is determined, data is saved related to the new event, and a description for the new event data is automatically provided.

### BACKGROUND OF THE INVENTION

Modem electronic devices provide users with a number of options for recording data related to a particular experience or event. For example, global positioning systems (“GPS”) are capable of recording (i.e., “remembering”) various locations that users have visited, digital cameras enable users to take digital photographs of events and share them with other users as electronic files over a computer network, such as the Internet, and voice recorders enable users to create digital audio files related to experiences or events. Many modem communications devices offer users a combination of the aforementioned options in a single device for recording experience-related data. For example, many communications networks now support cellular telephones capable of communicating data over the Internet and having integrated GPS functionality, digital cameras, and voice recorders, in addition to conventional telephone functions.

Currently, however, modem electronic and communications devices do not offer users the option to automatically correlate disparate experience-related information sets (e.g., voice recordings and digital photographs) while a user is experiencing a particular event. In particular, currently, users wishing to correlate disparate information sets must wait until after an event has occurred to collect or review the disparate information sets and determine when and where each information set (e.g., voice recordings and digital photographs) was recorded. Users must then manually correlate the data contained therein to cover a common experience or event. One drawback with current methods is that when users decide to correlate the experience-related information sets, they may have forgotten when and/or where certain events occurred. In particular, a user may fail to recall when and/or where certain photographs were taken and whether the photographs are related to voice recordings contained in digital audio files on the user's electronic or communications device. Moreover, currently, users of modem electronic and communications devices are unable to easily share or combine information sets relating to commonly shared experiences or events, which are recorded by multiple devices due to the fact that users are often unaware as to when a fellow user is collecting information which may be of interest.

### BRIEF SUMMARY OF THE INVENTION

In accordance with illustrative embodiments of the present invention, the above and other problems are addressed by methods and computer-readable media for creating a collection of experience-related data from disparate information sources.

According to one embodiment of the invention, a method includes receiving a marker indicating an experienced event, annotating the marker with the current state of environmental variables, saving data collected from the disparate information sources which is related to the experienced event, providing a description for the saved event data, and optionally, automatically sending the saved event data to an aggregation source in a communications network for retrieval. The marker may be a user input for initiating a voice recording on a communications device. The marker may also be automatically created upon receiving data related to one or more environmental variables in the communications device. The environmental variables may include global positioning system (“GPS”) information indicating the location of the communications device, the current time of day, and the current date. The saved data may include voice recordings or digital photographs related to the experienced event.

The method may further include monitoring the environmental variables and if a change in the environmental variables is detected, then determining the beginning of a new event, automatically monitoring the changed environmental variables, saving data related to the new event, automatically providing a description for the saved new event data, and optionally, automatically sending the saved new event data to an aggregation source for retrieval.

Other aspects of the invention may be implemented as a computer process executed on a communications device or as an article of manufacture such as a computer program product or computer-readable media. The computer program product may be a computer storage media readable by a computer system and encoding a computer program of instructions for executing a computer process. The computer program product may also be a propagated signal on a carrier readable by a computing system and encoding a computer program of instructions for executing a computer process.

These and various other features as well as advantages, which characterize the present invention, will be apparent from a reading of the following detailed description and a review of the associated drawings.

### BRIEF DESCRIPTION OF THE SEVERAL VIEWS OF THE DRAWINGS

FIG. 1 is a network diagram illustrating aspects of a communications network utilized in and provided by various illustrative embodiments of the invention;

FIG. 2 is a block diagram of the wireless device illustrated in FIG. 1, according to an illustrative embodiment of the invention; and

FIG. 3 is a flow diagram illustrating aspects of a process for creating a collection of experience-related data from disparate information sources in the communications network of FIG. 1, according to an illustrative embodiment of the invention.

### DETAILED DESCRIPTION OF THE INVENTION

Embodiments of the present invention provide methods, systems, and computer-readable media for creating a collection of experience-related data from disparate information sources in a communications network. In the following detailed description, references are made to the accompanying drawings that form a part hereof, and in which are shown by way of illustration specific embodiments or examples. Referring now to the drawings, in which like numerals represent like elements through the several figures, aspects of the present invention and the exemplary operating environment will be described.

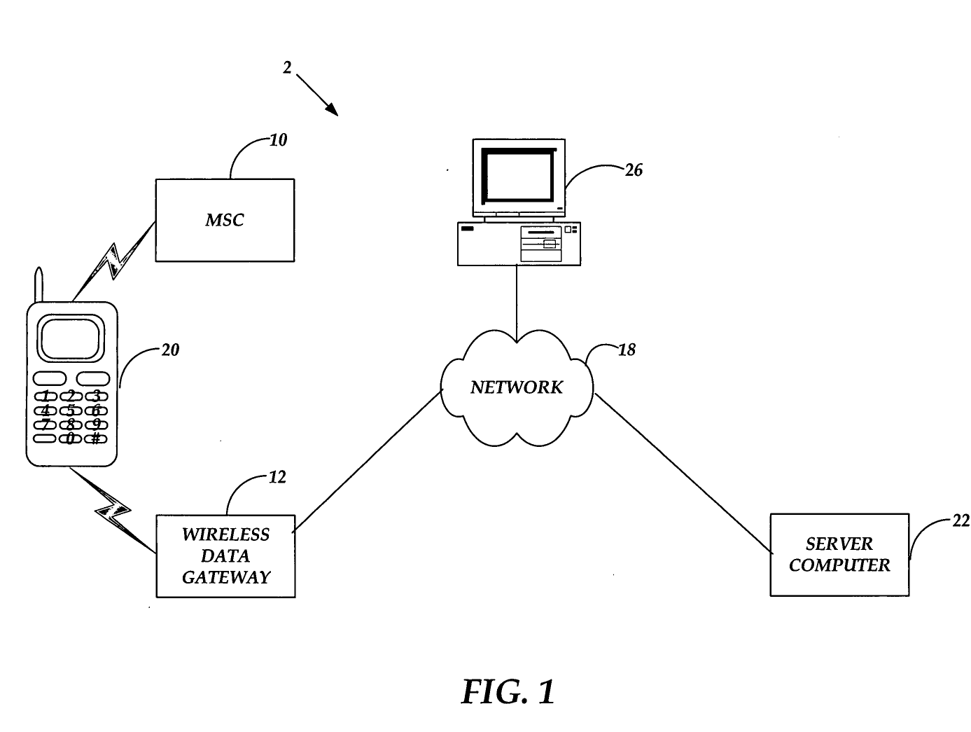

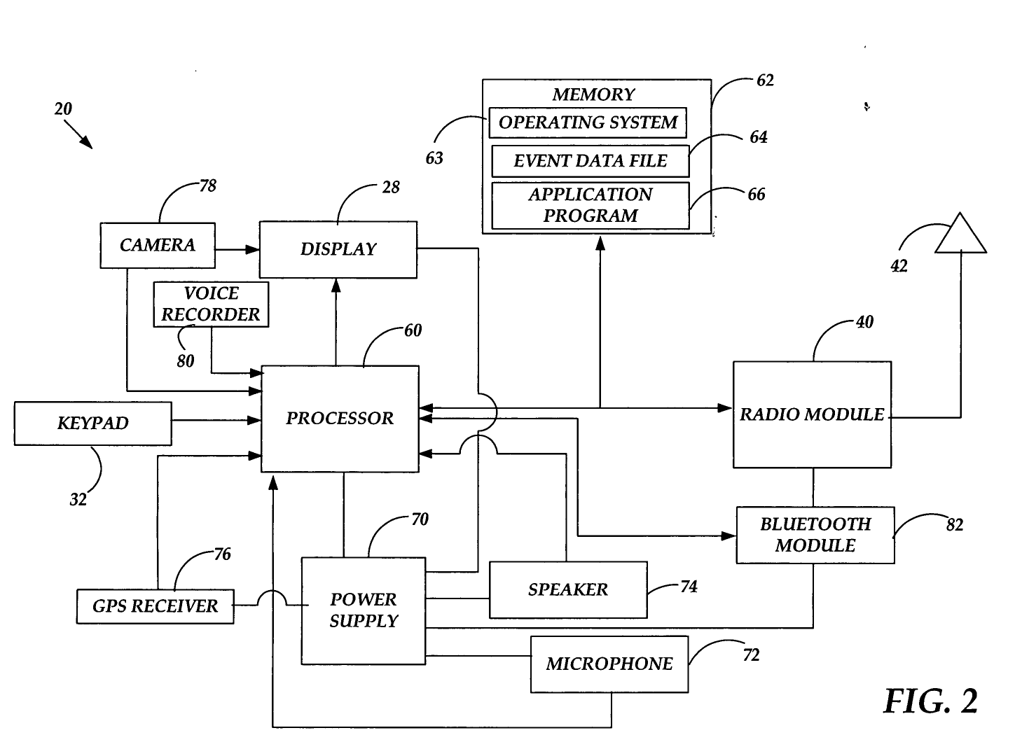

FIG. 1 and the following discussion are intended to provide a brief, general description of a suitable network environment in which the invention may be implemented. Referring now to FIG. 1, an illustrative communications network 2 for performing an illustrative embodiment of the invention will be described. As shown in FIG. 1, the communications network 2 includes a wireless communications device 20, utilized for voice and data communications. In one illustrative embodiment of the invention, the wireless communications device 20 may be a wireless telephone or “smartphone.” As appreciated by those skilled in the art, smartphones combine the functions of a conventional mobile telephone with functionality typically included in a hand-held computer such as a personal digital assistant (“PDA”). This functionality includes, but is not limited to installing and executing software application programs, Internet access, e-mail access, scheduling software, built-in camera, contact management, GPS navigation hardware and software, and Bluetooth. It will further be appreciate that the wireless communications device 20 may also be a standalone hand-held or portable computer capable of wireless communications in the communications network 2. The components and functionality of the wireless communications device 20 will be discussed in greater detail below with respect to FIG. 2.

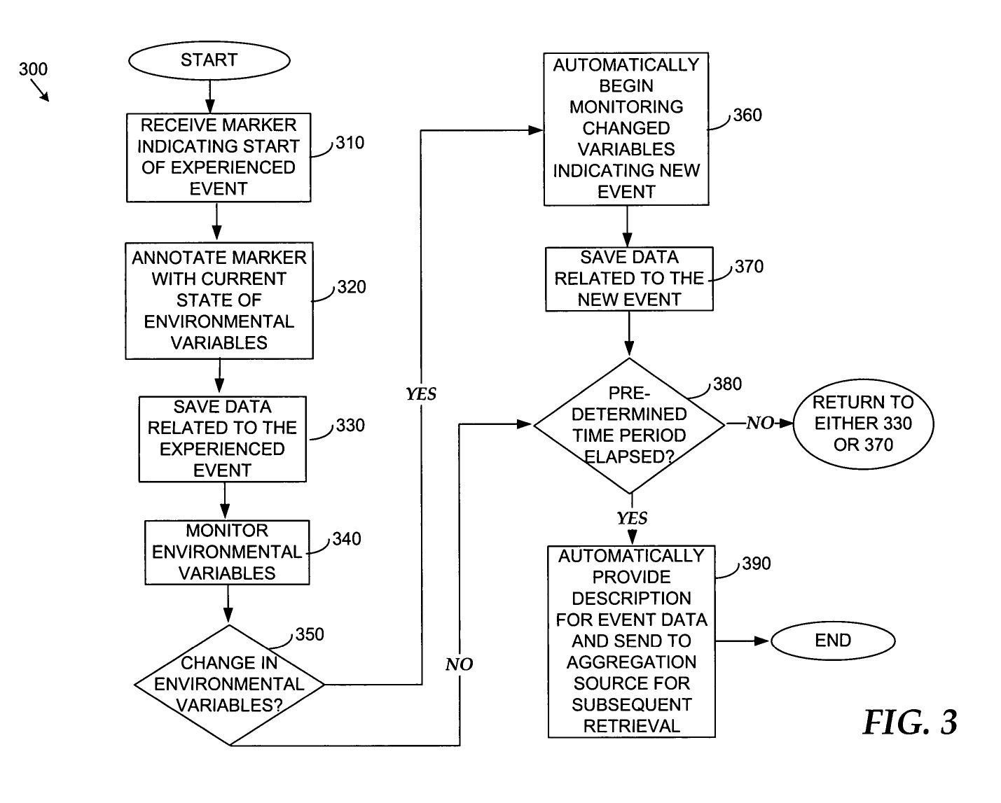

In the communications network 2, the wireless communications device 20 is in communication with a mobile switching center (“MSC”) 10. The MSC 10 is utilized to communicate voice calls from the wireless telephone 20 over the public switched telephone network (“PSTN”). The wireless communications device 20 is also in communication with a wireless data gateway 12 for communicating data messages over network 18. It should be appreciated that the network 18 may be a wide area computer network, such as the Internet. As is known to those skilled in the art, wireless data gateways enable wireless communication of data over a computer network. Those skilled in the art will further appreciate that the functions of the wireless data gateway 12 may be incorporated into the MSC 10. The communications network 2 also includes server computer 22. In an illustrative embodiment of the invention, the server computer 22 may function to deliver World Wide Web pages to connected devices over the network 18. Furthermore, as will be described in greater detail below with respect to FIG. 3, the server computer 22 may also function to serve as an aggregation source for experience-related event data collected by the wireless communication device 20.

The communications network 2 also includes a personal computer 26 in communication with the network 18. In one illustrative embodiment of the present invention, the personal computer 26 may function to receive data from the server computer 22 which is collected by the wireless communication device 22. In another illustrative embodiment of the present invention, the personal computer 26 may function independently of the server computer 22 as an aggregation source and receive experience-related event data from the wireless communication device 20. It should be understood by those skilled in the art that the server computer 22 and the personal computer 26 may communicate with the network 18 utilizing a variety of low speed and high speed connections, including, but not limited to, Integrated Services Digital Network (“ISDN”), Digital Subscriber Line (“DSL”), and Ti lines. It should be understood that the network 18 may also include a cellular network, a cable services network, a power line communication (“PLC”) network, satellite network, wireless fidelity (“Wi-Fi”) network, or IEEE 802.16 (“WiMAX”) network. These and other networks are well known to those skilled in the art.

Referring now to FIG. 2, the wireless communication device 20 will now be described in greater detail. As shown in FIG. 2, the wireless communication device 20 includes a processor 60 and a memory 62. In the wireless communications device 20, the processor 60 is connected to a display 28, a keypad 32, a radio module 40, a power supply 70, a microphone 72, a speaker 74, a GPS receiver 76, a camera 78, a voice recorder 80, and a Bluetooth module 82. The radio module 40 sends and receives voice and data via connected antenna 42.

It will be appreciated that in one illustrative embodiment of the present invention, the memory 62 may be a non-volatile memory such as “flash” memory. As is known to those skilled in the art, flash memory is a type of reprogrammable memory enabling its contents to be easily updated. The memory 62 stores an operating system 63, event data file 64, and application program 66. In the various illustrative embodiments of the present invention, the application program 66 functions to collect experience-related event data (such as digital photographs from the camera 78 and digital voice recordings from the voice recorder 80) in response to a user input (such as the initiation of a voice recording to memorialize the start of a vacation). The application program 66 also is operative to receive time and date information (e.g., from the MSC 10 or the network 18) and to receive location information from the GPS receiver 76 during the collection of event data. The application program 66 may also send and receive event data between the wireless communication device 20 and other wireless communication devices (not shown) within range via the Bluetooth module 82.

It should be understood that the wireless communication device 20 may also include alternative or additional components not specifically described herein. For instance, the wireless communication device 20 may also include a wireless fidelity (“Wi-Fi”) module for communicating data over 802.11 networks, in a manner known to those skilled in the art. Logical operations illustrating the operation of the application program 66 in collecting event data will be described in greater detail below with respect to FIG. 3.

Referring now to FIG. 3, an illustrative routine 300 will be described illustrating a process performed by the application program 66 on the wireless communication device 20 for creating a collection of experience-related (i.e., event) data from disparate information sources in the communications network 2. When reading the discussion of the routine presented herein, it should be appreciated that the logical operations of various embodiments of the present invention are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations illustrated in FIG. 3, and making up the embodiments of the present invention described herein are referred to variously as operations, structural devices, acts or modules. It will be recognized by one skilled in the art that these operations, structural devices, acts and modules may be implemented in software, in firmware, in special purpose digital logic, and any combination thereof without deviating from the spirit and scope of the present invention as recited within the claims set forth herein.

The routine 300 begins at operation 310, where the application program 66 receives a marker (i.e., a user input) on the wireless communication device 20 indicating the start of an experienced event. In particular, according to one illustrative embodiment of the present invention, a user may create a marker by pressing a button on the keypad 32 to initiate voice recording by the voice recorder 80 and record a notation, such as “I am currently in Asheville, N.C.” In another illustrative embodiment, the marker may be created by pressing a button on the keypad 32 which indicates the start of an event to the application program 66. In still another illustrative embodiment, the marker may be created automatically by the application program 66 upon deducing or inferring descriptive information for information being collected by the wireless communication device 20. For example, upon receiving GPS data from the GPS receiver 76 that the wireless communication device 20 is currently located in Asheville, N.C., the application program 66 may automatically create a marker. It should be understood that prior to creating the marker, a user of the wireless device 20 may execute the application program 66 and define initial parameters for collecting event data. For instance, a user may instruct the application program 66 to begin collecting data for a predetermined time period (i.e., a predetermined number of hours or days) or within a predetermined geographical area, after receiving a marker. The routine 300 continues from operation 310 at operation 320, where the application program 66 annotates the user-created marker with the current state of a set of environmental variables. In particular, as briefly discussed above in FIG. 2, the application program 66 is operative to receive time, date, and location information (i.e., environmental variables) during the collection of event data. For instance, upon receiving a marker comprising a voice recording (e.g., “I am beginning my summer vacation”), the application program 66 may be configured to automatically save the voice recording to the event data file 64 which includes a time/date stamp of when the voice recording was made. The application program 66 may also be configured to automatically request the location (e.g., Asheville, N.C.) of the wireless communication device 20 from the GPS receiver 76 and save the location data to the event data file 64. It should be understood that in accordance with the various illustrative embodiments of the present invention, the environmental variables are not limited to current time, date, and location information but may also include the most recent photograph taken with the camera 78, Bluetooth information from nearby devices identifying other users in the immediate area (e.g., family members) from the Bluetooth module 82, and broadcast (e.g., Wi-Fi) information from nearby local providers. It should be appreciated that the wireless communication device 20 may be configured with additional components or modules known to those skilled in the art for measuring additional environmental variables such as weather data (e.g., the current temperature), altitude, voice analysis data, and medical data (e.g., heart rate, blood sugar level, etc.).

The routine 300 continues from operation 320 at operation 330, where the application program 66 begins saving data received by the wireless communication device 20. In particular, after receiving a marker, annotating the marker with environmental variables, and saving the data associated with the marker and the environmental variables to the event data file 64 the application program 66 may be configured to save additional voice recordings and photographs to the event data file 64. For instance, after a marker is created from a voice recording (e.g., “I am beginning my summer vacation”), the application program 66 begins automatically saving any additional voice recordings or photographs to the event data file 64 until a predetermined time period has elapsed or a change in the initial environmental variables is detected, as will be discussed in greater detail below.

The routine 300 continues from operation 330 at operation 340, where the application program 66 begins monitoring the environmental variables whose initial values were saved to the event data file 64. For instance, the application program 66 may monitor the current time and date against the initial time/date stamp to determine when a predetermined time period, defined by a user of the wireless communication device 20, has elapsed. The application program 66 may also monitor the current GPS location of the wireless communication device 20 against the initial GPS location determined when the marker was received, to determine if the wireless communication device 20 has moved outside of geographical area.

The routine 300 continues from operation 340 at operation 350, where the application program 66 determines whether a change has occurred in the monitored environmental variables. For instance, the application program 66 may determine, based on monitored GPS location data, whether the wireless communication device 20 has moved out of the geographical area (e.g., Asheville, NC.) initially recorded when the marker was created by the user. It should be appreciated, that in one illustrative embodiment of the present invention, the application program 66 may be configured to monitor whether a change has occurred in a predetermined number of environmental variables. For instance, the application program 66 may be configured to determine when a change in over fifty percent of currently monitored environmental variables has occurred.

If, at operation 350, the application program 66 determines that a change in the monitored environmental variables has occurred, the routine 300 continues at operation 360 where the application program 66 determines that the current event has ended, saves the changed environmental variables to a new event data file, and automatically begins monitoring the changed environmental variables related to the new event. The routine 300 then continues from operation 360 at operation 370 where the application program 66 begins saving data received by the wireless communication device 20 to the new event data file as described above with respect to operation 330. As discussed above with respect to operation 350, a change in environmental variables which triggers the operation 360 may include a change in a single variable (e.g., GPS location) or a change in a predetermined number of variables (e.g., a change in over fifty percent of currently monitored variables). The operation 300 then continues from operation 370 to operation 380. Returning now to operation 350, if the application program 66 determines that a change in the monitored environmental variables has not occurred, the routine 300 then branches from operation 350 to operation 380.

At operation 380, the application program 66 determines whether a predetermined time period (defined by the user) has elapsed. For instance, if a user sets a predetermined time period to be four hours from the creation of a marker, then the application program 66 monitors the current time until four hours has elapsed. If, at operation 380, the application program 66 determines that the pre-determined time period has not elapsed, then the routine 300 returns to operation 330 (if a change in environmental variables has not occurred) or operation 370 (if a change in environmental variables has occurred) where the application program 66 continues to save data related to an event. If, at operation 380, the application program 66 determines that a predetermined time period has elapsed, then the routine 300 continues from operation 380 to operation 390.

At operation 390, the application program 66 automatically provides a description for each event data file and sends the event data file (or files) to an aggregation source (e.g., the server computer 22 or the personal computer 26) for subsequent retrieval by a user. It should be understood that in one illustrative embodiment, the operation 390 is optional. In particular, the saved event data may be aggregated locally or in a centralized manner. For example, the saved event data files (or files) may remain on an edge device (i.e., the wireless communication device 20) in the communications network 2. In another illustrative embodiment, only some of the event data (e.g., one of a collection of event data files) may be sent to an aggregation source while the other event data files remain on the edge device.

In one illustrative embodiment of the present invention, the description for the event data file may be formatted according to an extensible description syntax such as, for example, the Rich Site Summary, Resource Description Framework Site Summary, or Really Simple Syndication (collectively known as “RSS”) file formats. As known to those skilled in the art, RSS is a collection of XML formats for syndicating Web content. It should be understood that the description of the event data file may be determined by the application program 66 based on an automatically created marker or a marker created by a user. In particular, the application program 66 may be configured to generate a text string from a user created audio annotation, or other received data elements in the wireless communication device 20, marking the start of an event. For instance, the application program 66 may generate an event data file description based on an audio annotation (e.g., “The family trip to Ashville happened on the 2nd through the 5th of Aug., 2004.”). Alternatively, if no audio or text information is available for describing the event data or if a new event data file is automatically created based upon a change in environmental variables or after a predetermined time period has elapsed, then the application program 66 may generate an event data file description based on one or more current environmental variables. For instance, in generating the description “Asheville Trip” for an information set comprising an event data file, the application program 66 may utilize the GPS location (e.g., Asheville, N.C.) when the marker for the event data file was created and some other data element, such as a subsequent voice annotation in which the name “Asheville” is mentioned.

It will be appreciated that the event data file description describing the event data collected by the application program 66 may comprise a file including links to the individual data making up a particular event data file. For instance, the event data file description may include individual links (e.g., hyperlinks) to all of the photographs and voice annotations taken during a particular event which were communicated to the aggregation source. It should also be understood that the event data file description itself may comprise media content according to an extensible description syntax media format (e.g., the Media RSS format) and include all of the event data corresponding to a particular event. It should be further understood that the event data collected by the application program 66 may also include data collected from other wireless communication devices (e.g., via Bluetooth) in the vicinity of the wireless communication device 20 so that users experiencing shared events may retrieve all of the event data from a single aggregation source.

Based on the foregoing, it should be appreciated that the embodiments of the invention include methods, systems, and computer-readable media for creating a collection of experience-related data from disparate information sources. The above specification, examples and data provide a complete description of the manufacture and use of the composition of the invention. Since many embodiments of the invention can be made without departing from the spirit and scope of the invention, the invention resides in the claims hereinafter appended.

I claim:

1. A computer-implemented method for creating a collection of experience-related data from disparate information sources in a communications network, comprising:
receiving a marker indicating an experienced event;
annotating the marker with a current state of each of a plurality of environmental variables;
saving data related to the experienced event, wherein the data is collected from the disparate information sources; and
providing a description for the saved event data.

2. The method of claim 1 further comprising:
monitoring the plurality of environmental variables; and
if there is a change in at least one of the plurality of environmental variables, then determining the beginning of a new event;
automatically monitoring the changed environmental variables;
saving data related to the new event; and
automatically providing a description for the saved new event data.

3. The method of claim 1, wherein receiving a marker indicating an experienced event comprises receiving a user input for initiating a voice recording on a communications device.

4. The method of claim 3, wherein annotating the marker with a current state of each of a plurality of environmental variables comprises annotating the marker with a current global positioning system location of the communications device.

5. The method of claim 1, wherein annotating the marker with a current state of each of a plurality of environmental variables comprises annotating the marker with a current time of day and a current date.

6. The method of claim 2, further comprising:
automatically sending the saved event data to an aggregation source in the communications network for retrieval; and
automatically sending the saved new event data to the aggregation source for retrieval.

7. The method of claim 1, wherein saving data related to the experienced event comprises saving a voice recording related to the experienced event.

8. The method of claim 1, wherein saving data related to the experienced event comprises saving at least one digital photograph related to the experienced event.

9. The method of claim 1, wherein automatically sending the saved event data to an aggregation source for retrieval comprises:
determining a change in at least one of the plurality of environmental variables; and
in response to determining the change in at least one of the plurality of environmental variables, then automatically sending the saved event data to an aggregation source for retrieval.

10. The method of claim 1, wherein automatically sending the saved event data to an aggregation source for retrieval comprises:
determining whether a predetermined time period has elapsed; and
in response to determining that the predetermined time period has elapsed, then automatically sending the saved event data to an aggregation source for retrieval.

11. A computer-readable medium having computer-executable instructions, which when executed on a computer, cause the computer to perform a method for creating a collection of experience-related data from disparate information sources in a communications network, comprising:
receiving a marker indicating an experienced event;
annotating the marker with a current state of each of a plurality of environmental variables;
saving data related to the experienced event, wherein the data is collected from the disparate information sources; and
providing a description for the saved event data.

12. The computer-readable medium of claim 11 further comprising:
monitoring the plurality of environmental variables; and
if there is a change in at least one of the plurality of environmental variables, then
determining the beginning of a new event;
automatically monitoring the changed environmental variables;
saving data related to the new event; and
automatically providing a description for the saved new event data.

13. The computer-readable medium of claim 11, wherein receiving a marker indicating an experienced event comprises receiving a user input for initiating a voice recording on a communications device.

14. The computer-readable medium of claim 13, wherein annotating the marker with a current state of each of a plurality of environmental variables comprises annotating the marker with a current global positioning system location of the communications device.

15. The computer-readable medium of claim 11, wherein annotating the marker with a current state of each of a plurality of environmental variables comprises annotating the marker with a current time of day and a current date.

16. The computer-readable medium of claim 12, further comprising:
automatically sending the saved event data to an aggregation source in the communications network for retrieval; and
automatically sending the saved new event data to the aggregation source for retrieval.

17. The computer-readable medium of claim 11, wherein saving data related to the experienced event comprises saving a voice recording related to the experienced event.

18. The computer-readable medium of claim 11, wherein saving data related to the experienced event comprises saving at least one digital photograph related to the experienced event.

19. The computer-readable medium of claim 11, wherein automatically sending the saved event data to an aggregation source for retrieval comprises:
determining a change in at least one of the plurality of environmental variables; and
in response to determining the change in at least one of the plurality of environmental variables, then automatically sending the saved event data to an aggregation source for retrieval.

20. The computer-readable medium of claim 11, wherein automatically sending the saved event data to an aggregation source for retrieval comprises:
determining whether a predetermined time period has elapsed; and
in response to determining that the predetermined time period has elapsed, then automatically sending the saved event data to an aggregation source for retrieval.

21. A system for creating a collection of experience-related data from disparate information sources in a communications network, comprising:
a memory storage for storing executable program code and event data;
collection means for collecting the event data;
measuring means for measuring a current state of at least one of a plurality of environmental variables; and
a processor functionally coupled to the memory, the measurement means, and the collection means, the processor being responsive to computer-executable instructions contained in the program code, wherein the processor is configured to receive a marker indicating an experienced event, annotate the marker with a current state of each of the plurality of environmental variables, save data related to the experienced event, wherein the data is collected from the disparate information sources, and provide a description for the saved event data.
